(19) United States
(12) Patent Application Publication
(10) Pub. No.: US 2015/0067352 A1
(43) Pub. Date: Mar. 5, 2015

(54) Receptacle-Configured Cryptographic Device

(71) Applicant: L-3 Communications Corporation, New York, NY (US)

(72) Inventor: Richard Norman Winslow, Wilmington, DE (US)

(21) Appl. No.: 14/015,424

(22) Filed: Aug. 30, 2013

(51) Int. Cl. G06F 21/72

(52) U.S. Cl. CPC G06F 21/72
USPC 713/192

(57) ABSTRACT

Disclosed is a cryptographic device that may automatically configure its traffic interfaces and cryptographic modes when it is inserted into an electrically keyed receptacle in a host system. Such automatic configuration may enable a single cryptographic module to support a range of input/output interfaces, such as SPI, Ethernet, RS-232 Serial, and RS-485 Serial, for example, and also to support a range of cryptographic modes, such as Cipher Block Chaining, Galois Counter Mode, or Long Cycle Mode, for Communications Security (COMSEC) and Transmission Security (TRANSEC) purposes. In addition, such automatic configuration may include parameters that affect power consumption, such as device clock rate or other power management features.

### CROSS-REFERENCE TO RELATED APPLICATIONS

This application may include subject matter that is related to subject matter included in U.S. patent application Ser. No. [Attorney Docket No. LCOM_CDDDP_US01], entitled “CRYPTOGRAPHIC DEVICE WITH DETACHABLE DATA PLANE,” filed Aug. 30, 2013, the contents of which are hereby incorporated by reference in its entirety.

### BACKGROUND

Cryptographic devices are commonly used in robots and unmanned aerial vehicles (UAVs), particularly in defense applications. Various input/output interfaces are known for use in connection with such cryptographic devices, such as the serial peripheral interface (SPI) bus, Ethernet, RS-232 Serial, or RS-485 Serial, for example. Various cryptographic modes are also known for use in such cryptographic devices, such as Cipher Block Chaining, Galois Counter Mode, or Long Cycle Mode, for example. Such cryptographic devices may be used for Communications Security (COMSEC) and/or Transmission Security (TRANSEC) purposes.

There are, however, hundreds of models of already fielded UAVs and robots, and custom cryptographic devices specifically designed for each such platform are the norm. It would be desirable if there were a single cryptographic device that could be configured to operate with any of a large number of such platforms. It would be particularly desirable if such a cryptographic device were an embeddable cryptographic module that is capable of supporting various platforms that vary widely in terms of size, weight, and/or power (SWaP) requirements, data throughput, and/or type of cryptographic mode(s) supported for COMSEC and TRANSEC.

It would be impractical, however, to re-engineer hundreds of models of already fielded UAVs and robots to use a lowest common denominator cryptographic solution. For example, were one to produce a single cryptographic device to meet the lowest SWaP application, it might be infeasible to use that same device to meet higher-end throughput requirements. In addition, given the sheer number of already fielded UAVs and robots that would need to accommodate such a device, it would be infeasible for all of these devices to be adapted to any one common traffic interface.

It would be desirable, therefore, for any such cryptographic device to be capable of adapting itself to as many platforms as possible. It would be particularly desirable if such adaption were automatic at the time of use, because it may be the case that no user interface or trained personnel are available in the field to configure the cryptographic device.

### SUMMARY

As described herein, a universal cryptographic device may be deployed across a wide range of platforms, such as UAVs or robots, for example. Such a device may be deployed without the need for an operator interface to pre-configure the cryptographic device for any specific platform.

The cryptographic device may be configured to be inserted into a host platform receptacle. The host platform receptacle may be configured to receive the cryptographic device. Electrical keying in the host platform receptacle may be used to electrically signal a configuration of the inserted cryptographic device that is desirable for the specific platform with which the cryptographic device is to be used. Such electrical keying may be used to select one or more active traffic interfaces, one or more cryptographic modes, device clock rate, and other parameters that may be desirable to achieve compatibility between the cryptographic device and the specific platform with which it is to be used. Additional communication, such as negotiation of traffic options, for example, may occur between the cryptographic device and the host platform (via the host platform receptacle) based on the initial device insertion and recognition of the electrical key configuration.

The developer of the cryptographic device may determine which configurations of the cryptographic device should be supported, and may define an electrical keying scheme corresponding to those configurations. The keying scheme may be distributed to end equipment manufacturers. Thus, the end equipment manufacturers may be enabled to design and build a platform that is compatible with one or more of the supported cryptographic device configurations and that allows the embeddable cryptographic device to communicate over the existing communication bus(es) used by the host platform.

### BRIEF DESCRIPTION OF THE DRAWINGS

FIG. 1 is a functional block diagram of a universal cryptographic module and corresponding host platform cryptographic module receptacle.

FIGS. 2A and 2B depict an example universal cryptographic module.

FIG. 3 depicts the mating interface of an example universal cryptographic module.

FIG. 4 depicts a host platform cryptographic module receptacle.

### DETAILED DESCRIPTION

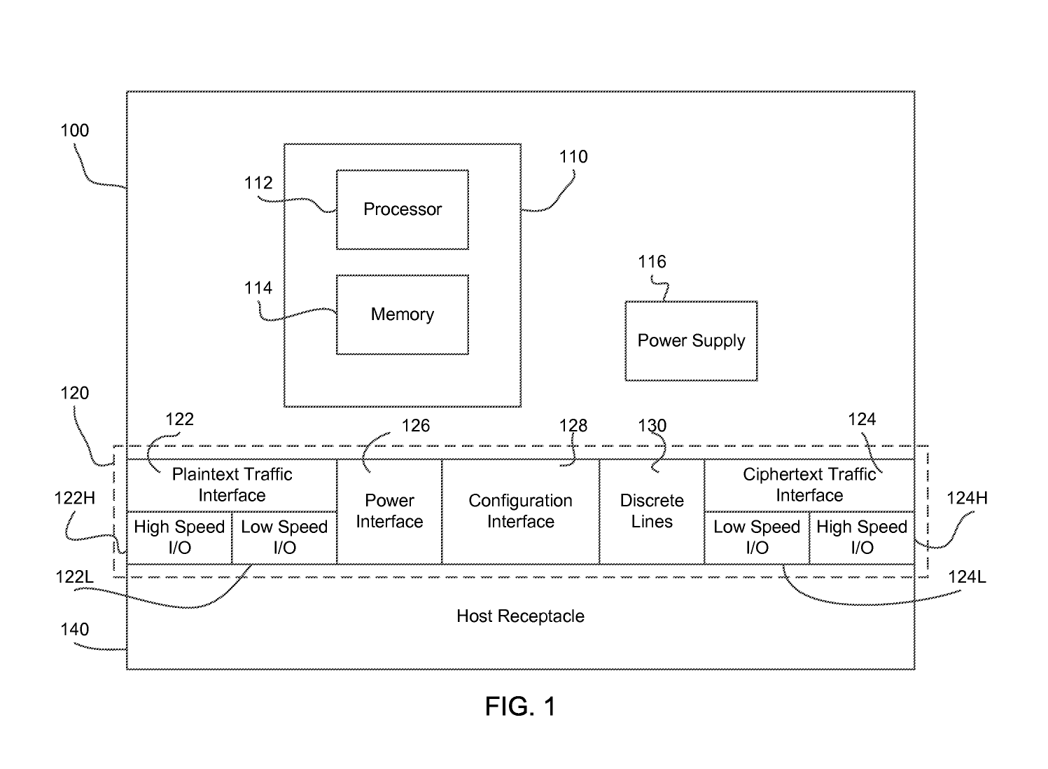

FIG. 1 is a functional block diagram of an example universal cryptographic module and an example host receptacle for operably connecting the universal cryptographic module to a host communication system. For example, a cryptographic module 100 may be configured to interface to a host platform cryptographic module receptacle 140. The host platform cryptographic receptacle 140 may be included on a communication bus of the host communication system. The communication bus may be configured to use a variety of communication protocols. For example, the communication bus may utilize one or more of Ethernet, SPI, RS-232, RS-422, RS-423, RS-485, Inter-Integrated Circuit (I²C), UNI/O, 1-Wire, Universal Serial Bus (USB), Aeronautical Radio, Incorporated (ARINC) 818, FireWire, and/or the like.

As shown, the cryptographic module 100 may include a main processing unit 110, and a power supply 116. The main processing unit 110 may include a processor 112 and a memory 114. The processor 112 may be a standalone microprocessor, or it may be instantiated as a hard or soft core within a programmable logic device, such as a field programmable gate array (FPGA), for example. The processor 112 may be configured to perform one or more of the functions or methods implemented by the cryptographic module 100 as described herein. The memory 114 may include one or more of volatile and/or non-volatile memory. The power supply 116 may be adapted to provide power to maintain volatile memory in the cryptographic module 100 should host-provided power be unavailable.

The cryptographic module 100 may include an input/output (I/O) interface 120, which may include an arrangement of electrically conductive pins and corresponding circuitry (not shown in FIG. 1). The cryptographic module 100 may be configured to mate the connector pins within the cryptographic module 100 with corresponding connector pins in the host platform receptacle 140. It should be understood that the module 100 may include any number of pins (e.g., 50), and that the pins may be arranged in any desired arrangement (e.g., a 2×25 array).

As shown, the I/O interface 120 may include, for example, one or more of a plaintext traffic interface 122, a ciphertext traffic interface 124, a power interface 126, and/or a configuration interface 128. The plaintext traffic interface 122 may be defined by a first distinct set of one or more specifically identified pins. The plaintext traffic interface 122 may be used for communicating plaintext data between the cryptographic module 100 and the host platform receptacle 140. Plaintext data may refer to data that is unencrypted. Plaintext data may also be referred to as red data.

The ciphertext traffic interface 124 may be defined by a second distinct set of one or more specifically identified pins. The ciphertext traffic interface 122 may be used for communicating ciphertext text between the cryptographic module 100 and the host platform receptacle 140. Ciphertext data may refer to data that is encrypted. Ciphertext data may also be referred to as black data. As an example, cryptographic module 100 may be configured to receive unencrypted data via the plaintext traffic interface 122, encrypt the data, and output the encrypted data via the ciphertext traffic interface 124. Similarly, cryptographic module 100 may be configured to receive encrypted data via the ciphertext traffic interface 124, decrypt the data, and output the decrypted data via the plaintext traffic interface 122.

The plaintext traffic interface 122 may include a high-speed I/O interface 122H and a low-speed I/O interface 122L. The high-speed I/O interface 122H may be defined by a distinct set of one or more specifically identified pins. The high-speed I/O interface 122H may be used for high-speed plaintext communications between the cryptographic module 100 and the host platform receptacle 140. Similarly, the low-speed I/O interface 122L may be defined by a distinct set of one or more specifically identified pins. The low-speed I/O interface 122L may be used for low-speed plaintext communications between the cryptographic module 100 and the host platform receptacle 140. Depending on the configuration and/or capabilities of the host communication system, the cryptographic module may be configured to communicate using one or more of the high-speed I/O interface 122H and/or the low-speed I/O interface 122L. For example, some relatively lower power communication systems may be configured to communicate using the low-speed I/O interface 122L, and some relatively higher power communication systems may be configured to communicate using the high-speed I/O interface 122H.

Similarly, the ciphertext traffic interface 124 may include a high-speed I/O interface 124H and a low-speed I/O interface 124L. The high-speed I/O interface 124H may be defined by a distinct set of one or more specifically identified pins. The high-speed I/O interface 124H may be used for high-speed ciphertext communications between the cryptographic module 100 and the host platform receptacle 140. Similarly, the low-speed I/O interface 124L may be defined by a distinct set of one or more specifically identified pins. The low-speed I/O interface 124L may be used for low-speed ciphertext communications between the cryptographic module 100 and the host platform receptacle 140. Depending on the configuration and/or capabilities of the host communication system, the cryptographic module may be configured to communicate using one or more of the high-speed I/O interface 124H and/or the low-speed I/O interface 124L. For example, some relatively lower power communication systems may be configured to communicate using the low-speed I/O interface 124L, and some relatively higher power communication systems may be configured to communicate using the high-speed I/O interface 124H.

The power interface 126 may be defined by a third distinct set of one or more specifically identified pins. The power interface 126 may be used to provide electrical power to the encryption module 100 from the host platform, via the host platform receptacle 140.

The configuration interface 128 may be defined by a fourth distinct set of one or more specifically identified pins. The configuration interface 128 may be used, in conjunction with a parent cryptographic device (not shown), to deliver one or more encryption keys to the cryptographic module 100. The encryption key may be stored in the memory 114. The processor 112 may use the encryption key to encrypt plaintext into ciphertext, and to decrypt plaintext from ciphertext, in accordance with an encryption algorithm, such as Advanced Encryption Standard (AES), for example, that is programmed into the main processing unit 110 and/or processor 112. Additional details regarding delivery of an encryption key to the encryption module 100 via the configuration interface 128 may be found in co-pending U.S. patent application attorney docket number LCOM_CDDDP_US01, filed on even date herewith, entitled “Cryptographic Device With Detachable Data Plane,” the disclosure of which is incorporated by reference herein in its entirety.

The I/O interface 120 may also include a number of discrete lines 128, each of which may be defined by a distinct set of one or more specifically identified pins. As described in detail herein, the discrete lines 128 may be used to determine from the host platform, via the host platform receptacle 140, whether certain features provided by the cryptographic module 100 should be activated or de-activated for the specific host platform with which the cryptographic module 100 is being operated. As an example, the electrical signals received from the host receptacle 140 via the discrete lines 130 may indicate the type of plaintext/ciphertext traffic interface to use (e.g., high speed, low speed, etc.), the type of communication protocol to use (e.g., Ethernet, RS-232, I²C, SPI, etc.), a clock speed used for communication, a type of power provided by the host communication system (e.g., via the power interface 126), a type of cryptographic mode to be utilized, and/or the like.

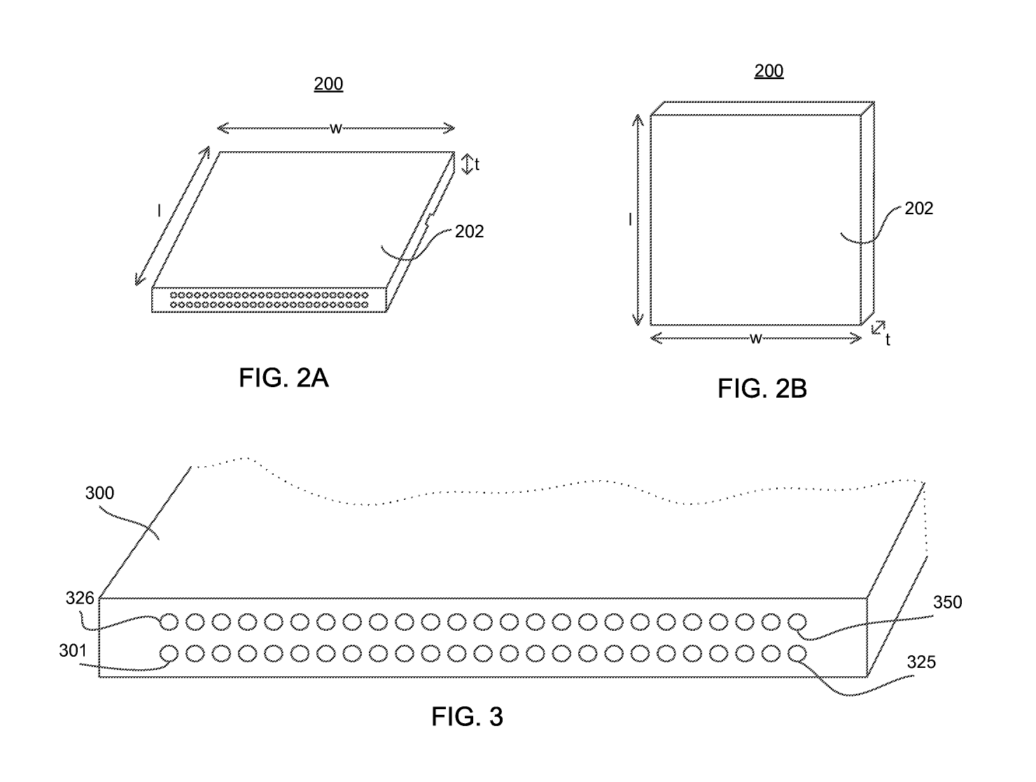

FIGS. 2A and 2B depict various views of an example cryptographic module 200. For example, a cryptographic module 200 may be an example embodiment of the encryption module 100 described in connection with FIG. 1. As shown, the encryption module 200 may be implemented using a commercial off-the-shelf (COTS) product and/or form factor, such as a standard CompactFlash card, for example, or a Personal Computer Memory Card International Association (PCMCIA) Cardbus or an ExpressCard. It should be understood, however, that the cryptographic module 200 may take other form factors.

The cryptographic module 200 may include a housing 202. The housing 202 may contain the processor, power supply, and pin arrangement described herein. The housing may be a plastic housing. A standard CompactFlash card typically includes such a housing.

The encryption module may have a length, l, of about 43 mm, for example, a width, w, of about 36 mm, for example, and a thickness, t, of about 3.3 mm, for example. These dimensions are typical for a standard COTS CompactFlash card. The encryption module may weigh approximately 20 grams (e.g., or less), for example, which is also typical for a standard COTS CompactFlash card. For example, if the cryptographic module is implemented using a CompactFlash form factor, the cryptographic module may weight approximately 10 grams. Such a relatively low SWaP profile may allow the cryptographic module to be used in conjunction with communication platforms of varying size, for example relatively small platforms where it may be desirable to utilize an embeddable cryptographic module that weighs approximately 20 grams or less.

The cryptographic module 200 may be adapted to mate with a corresponding host platform encryption device receptacle, such as the host platform receptacle 140 described in connection with FIG. 1. FIG. 3 depicts an example mating interface that may be configured for operably connecting a cryptographic module to a host communication system. For example, a mating interface 300 may be configured for operably (e.g., electrically) connecting a cryptographic module (e.g., such as the cryptographic module 200 of FIGS. 2A & 2B) to a host interface of a host communication system. As shown in FIG. 3, the mating interface 300 may include a plurality of apertures 301-350 through a front wall of the housing. Each aperture 301-350 may correspond to a respective mating pin enclosed within the housing.

In accordance with industry standards, the pin configuration for a CompactFlash card may be implemented as two rows of 25 pins each. The pins may be referred to as pins 1-26 along the bottom row from left to right as shown in FIG. 3, and pins 26-50 along the top row from left to right as shown in FIG. 3. Similarly, the apertures 301-350 may be arranged as two rows of 25 apertures each.

It should be understood that the encryption device could be packaged into a custom enclosure having a COTS interface for mating to the host platform. It should also be understood that the encryption device could be packaged into a completely proprietary form factor, with proprietary mating interfaces on both the cryptographic device and the host platform.

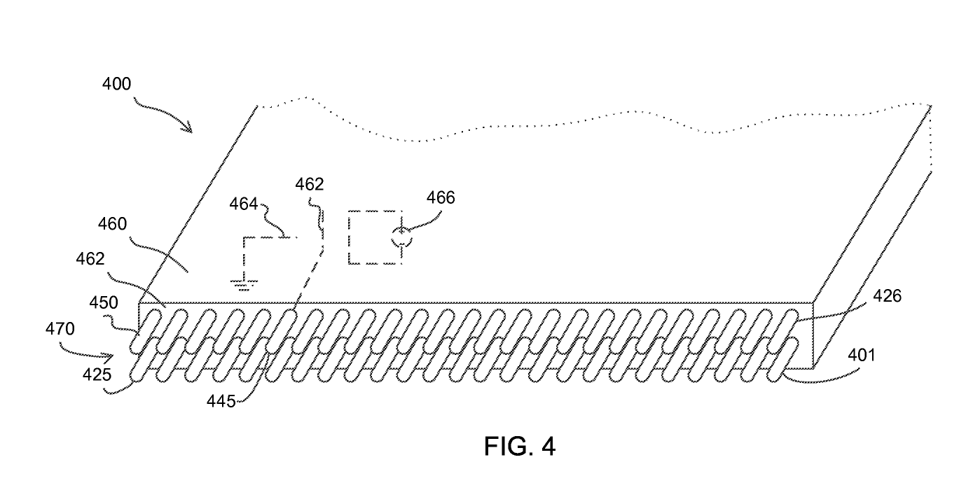

FIG. 4 depicts an example of a host platform cryptographic module receptacle 400 that may be configured to interface with a cryptographic module. For example, a host platform cryptographic module receptacle 400 may be an example embodiment of the host platform receptacle 140 described in connection with FIG. 1. The host platform cryptographic module receptacle 400 may be configured to interface with the mating interface 300 of FIG. 3. The host platform cryptographic module receptacle 400 may include a housing 460 and define a mating interface 470. As shown, the mating interface 470 may include an arrangement of electrically conductive pins 401-450 and corresponding circuitry. The pins 401-450 may extend through a front wall 462 of the housing 460.

The host platform cryptographic module receptacle 400 may be configured such that the connector pins in the host platform cryptographic module receptacle 400 mate with corresponding pins in the encryption module when the encryption module is inserted into the host platform cryptographic module receptacle 400. It should be understood that the host platform cryptographic module receptacle 400 may include any number of pins (e.g., 50), and that the pins may be arranged in any desired arrangement (e.g., a 2×25 array).

It should be understood that the form factor of the host platform device receptacle may be complementary to the form factor of the encryption device itself For example, if the encryption module is included in a CompactFlash card, then the device receptacle may be a corresponding CompactFlash socket. Similarly, if the encryption module is included in a PCMCIA Cardbus or ExpressCard, then the device receptacle may be a corresponding PCMCIA device socket. If the encryption module is packaged into a custom enclosure, then both the encryption module and the host platform receptacle may include corresponding COTS connectors for mating to one another. And, if the encryption module is designed with a proprietary form factor, then the host platform receptacle may have a corresponding proprietary configuration for receiving the module.

With reference to FIGS. 3 and 4, it should be understood that a plaintext traffic interface between the cryptographic module 300 and the host platform receptacle 400 may be defined by complementary sets of one or more pins on each of the cryptographic module 300 and the host platform receptacle 400. For example, pins 301 and 326 on the cryptographic module 300, and pins 401 and 426 on the host platform receptacle 400, may define the plaintext traffic interface between the cryptographic module 300 and the host platform receptacle 400. Pins 301 and 401 may provide for high-speed plaintext communication between the cryptographic module 300 and the host platform receptacle 400. Pins 326 and 426 may provide for low-speed plaintext communication between the cryptographic module 300 and the host platform receptacle 400.

Similarly, the ciphertext traffic, power, and configuration interfaces between the cryptographic module 300 and the host platform receptacle 400 may be defined by respective complementary sets of one or more pins on each of the cryptographic module 300 and the host platform receptacle 400.

The cryptographic module may be adapted to provide any number of features. Examples of such features include, without limitation, high-speed and low-speed ciphertext communication, high-speed and low-speed plaintext communication, any of a number of different clock rates, asynchronous and synchronous traffic protocols, and any of a number of cryptographic modes, such as CBC, Counter Mode, etc.

To enable the cryptographic module 300 to operate with any number of host platforms, the cryptographic module 300 may be selectively capable of providing, or not providing, any number of the features it is configured to be capable of providing. Accordingly, the cryptographic module 300 may be adapted to provide any number of features in a generic sense, and to selectively provide only certain features in a specific installation. For example, the cryptographic module 300 may be selectively capable of providing either high-speed or low-speed plaintext and ciphertext communications, employing either asynchronous or synchronous traffic protocol, employing any of a number of cryptographic modes (e.g., CBC, Counter Mode, etc.), operating using power supplies of varying voltage and/or current levels, and operating at any of a number of clock rates.

The features that the encryption module 300 is to provide for a specific installation may be determined from electrical communication with the host platform receptacle 400 upon insertion of the encryption module 300 into the host platform receptacle 400. As described above, the discrete lines may be used to determine from the host platform receptacle 400, whether certain features provided by the cryptographic module 300 should be activated or de-activated for the specific host platform with which the cryptographic module 300 is being operated.

Each of the discrete lines may be defined by respective complementary sets of one or more pins on each of the cryptographic module 300 and the host platform receptacle 400. To determine which features should be provided, certain pins on the host platform receptacle 400 may be configured to a pre-defined electrical state (e.g., pulled to ground, pulled high, etc.) in compliance with a pin allocation that may be defined for the cryptographic module. The pin allocation may designate which pins correspond to which features. The pin allocation may be provided to the host platform manufacturer in an Interface Control Document. Thus, the host platform manufacturer may hardwire the electrical states of the designated pins to convey to the cryptographic device 300 which features should be provided and which need not. In an example, the host platform manufacturer may use one or more jumpers in or to configure the designated pins to specified electrical states in order to convey to the cryptographic device 300 which features should be provided and which need not.

As shown in FIG. 4, a designated pin (e.g., pin 445) may be electrically coupled to circuitry that sets an electrical state of the designated pin 445. Functionally, such circuitry may be thought of a switch 462 that is adapted to set the electrical state of the designated pin 445 to a relatively low voltage state 464 (e.g., ground), or a relatively high voltage state 466 (e.g., 5 V). As the terms are used herein, relatively high and relatively low voltage states may be defined relative to one another (i.e., a pin that is set at a relatively high-voltage state is set at a higher voltage than is a pin that is set at a relatively low-voltage state).

When the cryptographic module 300 is inserted into the host platform receptacle 400, it may sense the electrical states of the designated pins, and can determine therefrom whether to activate or de-activate certain of the features that it is adapted to provide. Thus, the electrical states of the pins may be used to automatically configure, i.e., select the activation or deactivation of specific features within, the cryptographic module 300, without the use of a user interface in the field. This process may be referred to as electrically keying the cryptographic device 300.

The electrical keying can employ a predefined, one-to-one mapping of pin signals to features of the cryptographic device 300. For example, a certain pin of the host platform receptacle 400 being pulled low could be interpreted by the cryptographic module 300 as requiring activation of a serial communications interface. Alternatively, the electrical keying could treat pin signals as bits in a binary representation of multiple device features, where a binary 0 is interpreted from a pin being pulled low and a binary 1 is interpreted from a pin being pulled high, for example. A set of three pins, for example, could then be interpreted as an integer field having binary values from 000 through 111. Thus, a selection of eight device options may be determined from three pins.

In an example, the discrete lines may be used to represent an index that corresponds to a given configuration. For example, there may be 12 total configurations supported by a given cryptographic module, although more of fewer configurations may be supported in other examples. Each of the configurations may correspond to different combinations of supported features. For example, in some configurations the host communications may utilize a first clock rate (e.g., 10 MHz) and other configurations the host may utilize a second clock rate (e.g., 100 MHz). In some configurations the host communications may an asynchronous serial connection (e.g., a start symbol may be sent prior to each communicated byte) and other configurations the host may utilize a synchronous serial connection (e.g., using a master-slave relationship). In another example, there may be three different types of cryptographic modes supported by the cryptographic module, and a first communication system may utilize a first mode (e.g., Cipher Block Chaining), a second communication system may utilize a second mode (e.g., Galois Counter Mode), and a third communication system may utilize a third mode (e.g., Long Cycle Mode). Thus, the different combinations of clock rate, serial communication mode, and cryptographic mode may result in 12 different combinations of features. Four discrete lines may be used to indicate an index corresponding to the desired combination. For example, Table 1 indicates example indices that may be used to represent a given configuration.

TABLE 1

| | Discrete | Discrete | Discrete | Discrete | |
|---|---|---|---|---|---|
| | Line 1 | Line 2 | Line 3 | Line 4 | |
| Index Value | Value | Value | Value | Value | Supported Features |
| 0 | 0 | 0 | 0 | 0 | First Clock Rate, Asynchronous |
| | | | | | Serial, Cipher Block Chaining |
| 1 | 0 | 0 | 0 | 1 | First Clock Rate, Asynchronous |
| | | | | | Serial, Galois Counter Mode |
| 2 | 0 | 0 | 1 | 0 | First Clock Rate, Asynchronous |
| | | | | | Serial, Long Cycle Mode |
| 3 | 0 | 0 | 1 | 1 | First Clock Rate, Synchronous |
| | | | | | Serial, Cipher Block Chaining |
| 4 | 0 | 1 | 0 | 0 | First Clock Rate, Synchronous |
| | | | | | Serial, Galois Counter Mode |
| 5 | 0 | 1 | 0 | 1 | First Clock Rate, Synchronous |
| | | | | | Serial, Long Cycle Mode |
| 6 | 0 | 1 | 1 | 0 | Second Clock Rate, |
| | | | | | Asynchronous Serial, Cipher |
| | | | | | Block Chaining |
| 7 | 0 | 1 | 1 | 1 | Second Clock Rate, |
| | | | | | Asynchronous Serial, Galois |
| | | | | | Counter Mode |
| 8 | 1 | 0 | 0 | 0 | Second Clock Rate, |
| | | | | | Asynchronous Serial, Long Cycle |
| | | | | | Mode |
| 9 | 1 | 0 | 0 | 1 | Second Clock Rate, Synchronous |
| | | | | | Serial, Cipher Block Chaining |
| 10 | 1 | 0 | 1 | 0 | Second Clock Rate, Synchronous |
| | | | | | Serial, Galois Counter Mode |
| 11 | 1 | 0 | 1 | 1 | Second Clock Rate, Synchronous |
| | | | | | Serial, Long Cycle Mode |

| | |
|---|---|
| 12-15 | RESERVED/NOT USED |

Thus, in the example, shown in Table 1, the cryptographic module, upon being inserted into a host communication system receptacle may evaluate the state of discrete lines 1-4, which may correspond to identified pins of the electrical interface, to determine an appropriate clock rate, type of serial communication interface, and type of cryptographic mode to utilize when communicating with the host communication system. A ‘1’ may represent a pin that is tied to an electrical “high” value (e.g., 5 V, 3 V, etc.), while a ‘0’ may represent a pin that is tied to ground or an electrical “low” value (e.g., 0 V). When the host receptacle is installed on the host communication systems communication bus, the discrete pins may be electrically connected to high and/or low values that correspond to the index associated with the configuration of the cryptographic module that is to be used for the host communication system.

In another example, one or more sets of discrete lines may be associated with different features that the cryptographic module is adapted to provide. For example, a first set of one or more discrete lines may be used to indicate the type of cryptographic mode to use, a second set of one or more discrete lines may be used to indicate the clock speed to use, and a third set of one or more discrete lines may be used to indicate the type of serial communication to be used. For example, there may be three different types of cryptographic modes supported, and discrete lines 1 and 2 may be used to indicate the type of cryptographic mode to be used with a given communication system (e.g., ‘00’ may indicate Cipher Block Chaining, ‘01’ may indicate Galois Counter Mode, ‘10’ may indicate Long Cycle Mode, and ‘11’ may be reserved or unused). Similarly, there may be two different types of serial communication modes supported, and discrete line 3 may be used to indicate the type of serial communication mode to be used with a given communication system (e.g., ‘0’ may indicate Asynchronous Serial and ‘1’ may indicate Synchronous Serial). Similarly, there may be two different clock rates supported, and discrete line 4 may be used to indicate the clock rate to be used with a given communication system (e.g., ‘0’ may indicate a first clock rate and ‘1’ may a second clock rate). Table 2 indicates example values of the discrete lines when sets of discrete lines are used to indicate different parameters to be used in a given configuration.

TABLE 2

| | Discrete | Discrete | Discrete | Discrete | |
|---|---|---|---|---|---|
| | Line 1 | Line 2 | Line 3 | Line 4 | |
| | Value | Value | Value | Value | |
| | (Crypto | (Crypto | (Serial | (Clock | |
| Decimal Value | Mode) | Mode) | Mode) | Rate) | Supported Features |
| 0 | 0 | 0 | 0 | 0 | First Clock Rate, Asynchronous |
| | | | | | Serial, Cipher Block Chaining |
| 1 | 0 | 0 | 0 | 1 | Second Clock Rate, |
| | | | | | Asynchronous Serial, Cipher |
| | | | | | Block Chaining |
| 2 | 0 | 0 | 1 | 0 | First Clock Rate, Synchronous |
| | | | | | Serial, Cipher Block Chaining |
| 3 | 0 | 0 | 1 | 1 | Second Clock Rate, Synchronous |
| | | | | | Serial, Cipher Block Chaining |
| 4 | 0 | 1 | 0 | 0 | First Clock Rate, Asynchronous |
| | | | | | Serial, Galois Counter Mode |
| 5 | 0 | 1 | 0 | 1 | Second Clock Rate, |
| | | | | | Asynchronous Serial, Galois |
| | | | | | Counter Mode |
| 6 | 0 | 1 | 1 | 0 | First Clock Rate, Synchronous |
| | | | | | Serial, Galois Counter Mode |
| 7 | 0 | 1 | 1 | 1 | Second Clock Rate, Synchronous |
| | | | | | Serial, Galois Counter Mode |
| 8 | 1 | 0 | 0 | 0 | First Clock Rate, Asynchronous |
| | | | | | Serial, Long Cycle Mode |
| 9 | 1 | 0 | 0 | 1 | Second Clock Rate, |
| | | | | | Asynchronous Serial, Long Cycle |
| | | | | | Mode |
| 10 | 1 | 0 | 1 | 0 | First Clock Rate, Synchronous |
| | | | | | Serial, Long Cycle Mode |
| 11 | 1 | 0 | 1 | 1 | Second Clock Rate, Synchronous |
| | | | | | Serial, Long Cycle Mode |

| | |
|---|---|
| 12-15 | RESERVED/NOT USED |

After and/or during the electrical keying recognition process, the cryptographic module 300 and the host platform may engage in additional communication to negotiate further traffic options. Such negotiation may utilize the point-to-point protocol (PPP) Vendor Protocol as defined in IETF RFC-3772, for example. In an example, the electrical keying may be indicative of the initial communications interface over which extended interfacing negotiations are to be performed. The extended negotiations may be used to establish the actual configuration to be used for a traffic encryption/decryption session. For example, a certain pin being pulled low could indicate to the encryption module 300 that PPP communication negotiations are to be started on a serial interface with the host platform.

If PPP communications negotiations are invoked after the cryptographic module implements the initial configuration based on the electrical keying of the host receptacle, the cryptographic module may participate in connection establishment procedure (e.g., per Point-to-Point Protocol (PPP) IETF RFC 1661) by for example by performing one or more of link establishment, authentication, and/or network-layer protocol negations. The connection establishment procedure may be performed (e.g., if invoked) on a per-interface basis (e.g., performed on or more of the ciphertext interface and/or plaintext interface of the cryptographic device). For example, the cryptographic device may perform the connection establishment procedure with a radio controller on the ciphertext interface and with a different processing unit on the plaintext interface.

Link establishment, authentication, and/or network-layer protocol negations , negotiations may be performed regarding how the data is to be passed between the cryptographic module interface and the host platform, for example before and after encryption/decryption. For example, how the communicated data is to be framed, how the communicated data is to be compressed, Internet Protocol (IP) settings, and/or the like may be negotiated. This negotiation may invoke provisions of PPP Vendor Protocol per IETF RFC 3772 to negotiate vendor-specific provisions for network protocols and/or authentication protocols. Once PPP negotiations complete the cryptographic module and the host platform may utilize the negotiated connection to pass data and/or control traffic for the duration of the operating session. Communications on an interface may be renegotiated using PPP during the operating session. At the end of the session the PPP connection may be terminated, for example using a PPP link termination procedure.

1. A cryptographic system, comprising:
a cryptographic module that is adapted to perform encryption and decryption; and
a host platform receptacle that is adapted to receive the cryptographic module,
wherein the cryptographic module has a plurality of electrically conductive pins, and is adapted to determine from an electrical state of a designated one of the plurality of electrically conductive pins whether to activate a feature provided by the cryptographic module.

2. The cryptographic system of claim 1, wherein the cryptographic module weighs 20 grams or less.

3. The cryptographic system of claim 1, wherein the cryptographic module is implemented in a CompactFlash form factor.

4. The cryptographic system of claim 1, wherein the feature provided by the cryptographic module is one of high-speed or low-speed plaintext data communications between the cryptographic module and the host platform receptacle.

5. The cryptographic system of claim 1, wherein the feature provided by the cryptographic module is one of high-speed or low-speed ciphertext data communications between the cryptographic module and the host platform receptacle.

6. The cryptographic system of claim 1, wherein the feature provided by the cryptographic module is one of a plurality of communication protocol types.

7. The cryptographic system of claim 1, wherein the feature provided by the cryptographic module is one of a plurality of clock speeds.

8. The cryptographic system of claim 1, wherein the feature provided by the cryptographic module is one of a plurality of power types provided by a host communication system with which the cryptographic module interfaces.

9. The cryptographic system of claim 1, wherein the feature provided by the cryptographic module is one of a plurality of cryptographic modes.

10. The cryptographic system of claim 1, wherein the feature provided by the cryptographic module is one of a plurality of bus types.

11. The cryptographic system of claim 1, wherein the host platform receptacle has a plurality of electrically conductive pins that correspond to the plurality of electrically conductive pins of the cryptographic module, and wherein the electrical state of the designated one of the plurality of pins is set by an electrical state of a corresponding pin of the host platform receptacle.

12. A cryptographic module, comprising:
a processing unit that is adapted to execute an encryption algorithm;
a plurality of electrically conductive pins that are arranged such that the cryptographic module may mate with a corresponding host platform receptacle,
wherein the cryptographic module is adapted to provide a plurality of features, and the processing unit is adapted to determine from an electrical state of a designated one of the plurality of electrically conductive pins whether to activate a feature provided by the cryptographic module.

13. The cryptographic module of claim 12, wherein the electrical state of the designated one of the plurality of pins is one of a relatively high voltage or a relatively low voltage.

14. The cryptographic module of claim 12, wherein the processing unit is adapted to determine whether to activate one or more of the features from respective electrical states of the plurality of electrically conductive pins based on a predefined, one-to-one mapping of features to pin signals.

15. The cryptographic module of claim 12, wherein the processing unit is adapted to determine whether to activate one or more of the features from respective electrical states of the plurality of electrically conductive pins based on an electrical keying that treats pin signals as bits in a binary representation of multiple device features.

16. The cryptographic system of claim 12, wherein the cryptographic module weighs less than about 20 grams.

17. The cryptographic system of claim 12, wherein the cryptographic module is a CompactFlash card.

18. A host platform cryptographic module receptacle, comprising:
an interface for mating the receptacle with a compatible cryptographic module, the cryptographic module being adapted to execute an encryption algorithm and comprising a first plurality of electrically conductive pins;
a second plurality of electrically conductive pins corresponding to the first plurality of electrically conductive pins; and
electrical circuitry that sets each of the second plurality of electrically conductive pins to a respective electrical state, such that, when the cryptographic module is mated with the receptacle, the cryptographic module can determine from the electrical states of the first plurality of electrically conductive pins whether to activate associated features that the cryptographic module is adapted to provide.

19. The receptacle of claim 18, wherein the electrical circuitry sets the respective electrical states of the second plurality of electrically conductive pins based on a predefined, one-to-one mapping of features to pin signals.

20. The receptacle of claim 18, wherein the electrical circuitry sets the respective electrical states of the second plurality of electrically conductive pins based on an electrical keying that treats pin signals as bits in a binary representation of multiple device features.
